(19) United States
(12) Patent Application Publication
(10) Pub. No.: US 2014/0164132 A1
(43) Pub. Date: Jun. 12, 2014

(54) Client-Side Advertising Decisions

(71) Applicants: Teck Chia, Redwood City, CA (US); Deborah Liu, Palo Alto, CA (US); Vijaye Raji, Palo Alto, CA (US)

(72) Inventors: Teck Chia, Redwood City, CA (US); Deborah Liu, Palo Alto, CA (US); Vijaye Raji, Palo Alto, CA (US)

(21) Appl. No.: 13/712,551

(22) Filed: Dec. 12, 2012

(51) Int. Cl. G06Q 30/02

(52) U.S. Cl. CPC G06Q 30/0251
USPC 705/14.64; 705/14.49

(57) ABSTRACT

In one embodiment, a method includes a client computing device receiving one or more advertisements for presentation to a user associated with the client computing device. The client computing device selects from among the received advertisements for presentation to the user based on information stored locally on the client computing device and associated with a value of the advertisements with respect to the user. The client computing device then presents to the user one or more of the selected advertisements to the user.

### TECHNICAL FIELD

This disclosure generally relates to electronic advertising.

### BACKGROUND

Electronic advertising spaces provide advertisers with a venue for displaying electronic advertisements to consumers of the advertisement. Electronic advertising spaces may exist on electronic displays of various sizes. Displays may exist on mobile devices (such as smart phones), laptops, personal computers, televisions, kiosks, and billboards. Electronic advertisements may be delivered to a device from various entities, such as directly from the advertiser, from an agent of the advertiser (such as an advertising clearinghouse), or from the operator of an advertisement bidding system. The operator of an advertisement bidding system may accept or request one or more bids from one or more advertisers to place an advertisement in one or more advertising spaces.

### SUMMARY OF PARTICULAR EMBODIMENTS

A computing client device may select among received advertisements to display to a user. The client device receives one or more advertisements to display to a user. In particular embodiments, the received advertisements have been pre-filtered or pre-selected for the user, for example by being targeted to the user or the specific client device. The client device selects among the received advertisements based on information associated with a value of the advertisements with respect to the user. Such information could include information about the user, the user's preferences, applications installed or used by the user, interactions a user has with the client device or specific applications on the client device, information relating to other individuals with similar characteristics or interests as the user, or any other suitable information. In particular embodiments, such information is associated with a social-networking system. After selecting the advertisements, the client device displays one or more of the selected advertisements to the user. Advertisements may be displayed in any suitable way, such as on a webpage, in an application, on a social networking system, or any other suitable way. Advertisements may be displayed in any suitable location, and in particular embodiments, the advertisements may be displayed at a location with which the user may be more likely to interact with or notice the advertisement.

### BRIEF DESCRIPTION OF THE DRAWINGS

FIG. 1 illustrates an example network environment associated with a social-networking system.

FIG. 2 illustrates an example social graph.

FIG. 3 illustrates an example method for filtering and selecting advertisements to display to a user of a client device.

FIG. 4 illustrates an example method for presenting a promoted content object to a user of a client device.

FIG. 5 illustrates an example computer system.

### DESCRIPTION OF EXAMPLE EMBODIMENTS

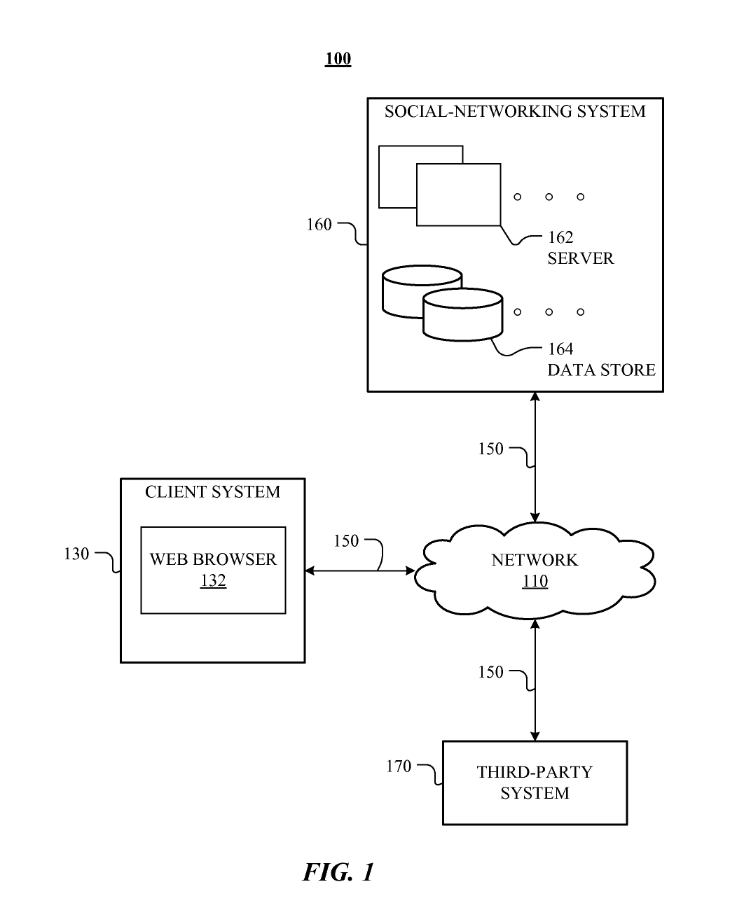

FIG. 1 illustrates an example network environment 100 associated with a social-networking system. Network environment 100 includes a client system 130, a social-networking system 160, and a third-party system 170 connected to each other by a network 110. Although FIG. 1 illustrates a particular arrangement of client system 130, social-networking system 160, third-party system 170, and network 110, this disclosure contemplates any suitable arrangement of client system 130, social-networking system 160, third-party system 170, and network 110. As an example and not by way of limitation, two or more of client system 130, social-networking system 160, and third-party system 170 may be connected to each other directly, bypassing network 110. As another example, two or more of client system 130, social-networking system 160, and third-party system 170 may be physically or logically co-located with each other in whole or in part. Moreover, although FIG. 1 illustrates a particular number of client systems 130, social-networking systems 160, third-party systems 170, and networks 110, this disclosure contemplates any suitable number of client systems 130, social-networking systems 160, third-party systems 170, and networks 110. As an example and not by way of limitation, network environment 100 may include multiple client system 130, social-networking systems 160, third-party systems 170, and networks 110.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Links 150 may connect client system 130, social-networking system 160, and third-party system 170 to communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

In particular embodiments, client system 130 may be an electronic device including hardware, software, or embedded logic components or a combination of two or more such components and capable of carrying out the appropriate functionalities implemented or supported by client system 130. As an example and not by way of limitation, a client system 130 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client systems 130. A client system 130 may enable a network user at client system 130 to access network 110. A client system 130 may enable its user to communicate with other users at other client systems 130.

In particular embodiments, client system 130 may include a web browser 132, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 130 may enter a Uniform Resource Locator (URL) or other address directing the web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to client system 130 one or more Hyper Text Markup Language (HTML) files responsive to the HTTP request. Client system 130 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 160 may be a network-addressable computing system that can host an online social network. Social-networking system 160 may generate, store, receive, and send social-networking data, such as, for example, user-profile data, concept-profile data, social-graph information, or other suitable data related to the online social network. Social-networking system 160 may be accessed by the other components of network environment 100 either directly or via network 110. In particular embodiments, social-networking system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof In particular embodiments, each server 162 may include hardware, software, or embedded logic components or a combination of two or more such components for carrying out the appropriate functionalities implemented or supported by server 162. In particular embodiments, social-networking system 164 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, or a third-party system 170 to manage, retrieve, modify, add, or delete, the information stored in data store 164.

In particular embodiments, social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. Social-networking system 160 may provide users of the online social network the ability to communicate and interact with other users. In particular embodiments, users may join the online social network via social-networking system 160 and then add connections (e.g. relationships) to a number of other users of social-networking system 160 whom they want to be connected to. Herein, the term “friend” may refer to any other user of social-networking system 160 with whom a user has formed a connection, association, or relationship via social-networking system 160.

In particular embodiments, social-networking system 160 may provide users with the ability to take actions on various types of items or objects, supported by social-networking system 160. As an example and not by way of limitation, the items and objects may include groups or social networks to which users of social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 160 or by an external system of third-party system 170, which is separate from social-networking system 160 and coupled to social-networking system 160 via a network 110.

In particular embodiments, social-networking system 160 may be capable of linking a variety of entities. As an example and not by way of limitation, social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating social-networking system 160. In particular embodiments, however, social-networking system 160 and third-party systems 170 may operate in conjunction with each other to provide social-networking services to users of social-networking system 160 or third-party systems 170. In this sense, social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 160 also includes user-generated content objects, which may enhance a user's interactions with social-networking system 160. User-generated content may include anything a user can add, upload, send, or “post” to social-networking system 160. As an example and not by way of limitation, a user communicates posts to social-networking system 160 from a client system 130. Posts may include data such as status updates or other textual data, location information, photos, videos, links, music or other similar data or media. Content may also be added to social-networking system 160 by a third-party through a “communication channel,” such as a newsfeed or stream.

In particular embodiments, social-networking system 160 may include a variety of servers, sub-systems, programs, modules, logs, and data stores. In particular embodiments, social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 160 may also include suitable components such as network interfaces, security mechanisms, load balancers, failover servers, management-and-network-operations consoles, other suitable components, or any suitable combination thereof. In particular embodiments, social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 160 to one or more client systems 130 or one or more third-party system 170 via network 110. The web server may include a mail server or other messaging functionality for receiving and routing messages between social-networking system 160 and one or more client systems 130. An API-request server may allow a third-party system 170 to access information from social-networking system 160 by calling one or more APIs. An action logger may be used to receive communications from a web server about a user's actions on or off social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from client system 130 responsive to a request received from client system 130. Authorization servers may be used to enforce one or more privacy settings of the users of social-networking system 160. A privacy setting of a user determines how particular information associated with a user can be shared. The authorization server may allow users to opt in or opt out of having their actions logged by social-networking system 160 or shared with other systems (e.g. third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

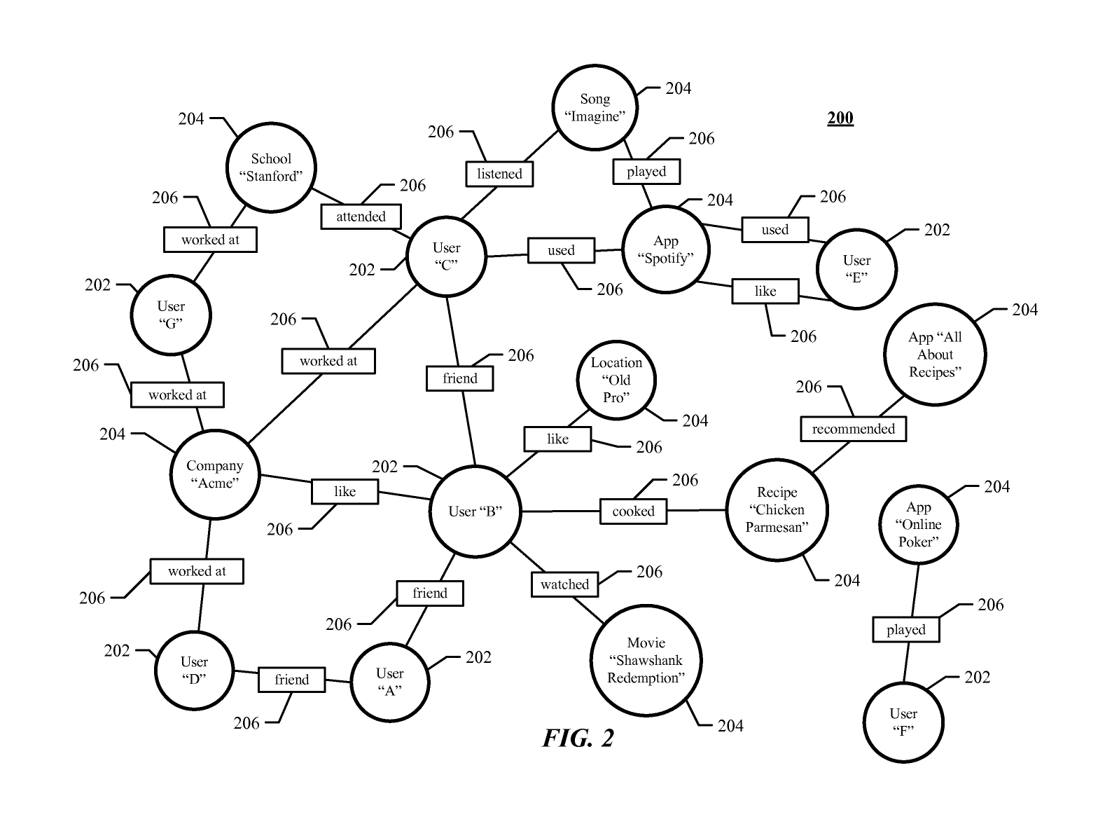

FIG. 2 illustrates example social graph 200. In particular embodiments, social-networking system 160 may store one or more social graphs 200 in one or more data stores. In particular embodiments, social graph 200 may include multiple nodes—which may include multiple user nodes 202 or multiple concept nodes 204—and multiple edges 206 connecting the nodes. Example social graph 200 illustrated in FIG. 2 is shown, for didactic purposes, in a two-dimensional visual map representation. In particular embodiments, a social-networking system 160, client system 130, or third-party system 170 may access social graph 200 and related social-graph information for suitable applications. The nodes and edges of social graph 200 may be stored as data objects, for example, in a data store (such as a social-graph database). Such a data store may include one or more searchable or queryable indexes of nodes or edges of social graph 200.

In particular embodiments, a user node 202 may correspond to a user of social-networking system 160. As an example and not by way of limitation, a user may be an individual (human user), an entity (e.g. an enterprise, business, or third-party application), or a group (e.g. of individuals or entities) that interacts or communicates with or over social-networking system 160. In particular embodiments, when a user registers for an account with social-networking system 160, social-networking system 160 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with social-networking system 160. In particular embodiments, a user node 202 may be associated with information provided by a user or information gathered by various systems, including social-networking system 160. As an example and not by way of limitation, a user may provide his or her name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more webpages.

In particular embodiments, a concept node 204 may correspond to a concept. As an example and not by way of limitation, a concept may correspond to a place (such as, for example, a movie theater, restaurant, landmark, or city); a website (such as, for example, a website associated with social-network system 160 or a third-party website associated with a web-application server); an entity (such as, for example, a person, business, group, sports team, or celebrity); a resource (such as, for example, an audio file, video file, digital photo, text file, structured document, or application) which may be located within social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 204 may be associated with information of a concept provided by a user or information gathered by various systems, including social-networking system 160. As an example and not by way of limitation, information of a concept may include a name or a title; one or more images (e.g. an image of the cover page of a book); a location (e.g. an address or a geographical location); a website (which may be associated with a URL); contact information (e.g. a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more webpages.

In particular embodiments, a node in social graph 200 may represent or be represented by a webpage (which may be referred to as a “profile page”). Profile pages may be hosted by or accessible to social-networking system 160. Profile pages may also be hosted on third-party websites associated with a third-party server 170. As an example and not by way of limitation, a profile page corresponding to a particular external webpage may be the particular external webpage and the profile page may correspond to a particular concept node 204. Profile pages may be viewable by all or a selected subset of other users. As an example and not by way of limitation, a user node 202 may have a corresponding user-profile page in which the corresponding user may add content, make declarations, or otherwise express himself or herself. As another example and not by way of limitation, a concept node 204 may have a corresponding concept-profile page in which one or more users may add content, make declarations, or express themselves, particularly in relation to the concept corresponding to concept node 204.

In particular embodiments, a concept node 204 may represent a third-party webpage or resource hosted by a third-party system 170. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g. “eat”), causing a client system 130 to send to social-networking system 160 a message indicating the user's action. In response to the message, social-networking system 160 may create an edge (e.g. an “eat” edge) between a user node 202 corresponding to the user and a concept node 204 corresponding to the third-party webpage or resource and store edge 206 in one or more data stores.

In particular embodiments, a pair of nodes in social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, social-networking system 160 may send a “friend request” to the second user. If the second user confirms the “friend request,” social-networking system 160 may create an edge 206 connecting the first user's user node 202 to the second user's user node 202 in social graph 200 and store edge 206 as social-graph information in one or more of data stores 24. In the example of FIG. 2, social graph 200 includes an edge 206 indicating a friend relation between user nodes 202 of user “A” and user “B” and an edge indicating a friend relation between user nodes 202 of user “C” and user “B.” Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to a edge type or subtype. A concept-profile page corresponding to a concept node 204 may include, for example, a selectable “check in” icon (such as, for example, a clickable “check in” icon) or a selectable “add to favorites” icon. Similarly, after a user clicks these icons, social-networking system 160 may create a “favorite” edge or a “check in” edge in response to a user's action corresponding to a respective action. As another example and not by way of limitation, a user (user “C”) may listen to a particular song (“Ramble On”) using a particular application (SPOTIFY, which is an online music application). In this case, social-networking system 160 may create a “listened” edge 206 and a “used” edge (as illustrated in FIG. 2) between user nodes 202 corresponding to the user and concept nodes 204 corresponding to the song and application to indicate that the user listened to the song and used the application. Moreover, social-networking system 160 may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Imagine”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “E” and concept node 204 for “SPOTIFY”).

In particular embodiments, social-networking system 160 may create an edge 206 between a user node 202 and a concept node 204 in social graph 200. As an example and not by way of limitation, a user viewing a concept-profile page (such as, for example, by using a web browser or a special-purpose application hosted by the user's client system 130) may indicate that he or she likes the concept represented by the concept node 204 by clicking or selecting a “Like” icon, which may cause the user's client system 130 to send to social-networking system 160 a message indicating the user's liking of the concept associated with the concept-profile page. In response to the message, social-networking system 160 may create an edge 206 between user node 202 associated with the user and concept node 204, as illustrated by “like” edge 206 between the user and concept node 204. In particular embodiments, social-networking system 160 may store an edge 206 in one or more data stores. In particular embodiments, an edge 206 may be automatically formed by social-networking system 160 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

In particular embodiments, information about a user's interaction with a client device or application on the client device may be received and/or stored by a platform operator associated with the client device or application. As an example and not by way of limitation, a client device may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. Platform operators may be an operator of an operating system on the client, an operator of specific applications or software running on the client device, an operator of a social-network, an operator of servers communicating with the client device, or any other suitable platform operator. A platform operator may specify particular requirements that an application running on the client device must meet, such as requirements that the application comply with specifications regarding communication between the client device and the platform operator. Specifications may be of any suitable type, such as, for example, those described by software development kits or requirements for particular features such as single sign-on functionality. In addition or the alternative, a platform operator may implement a uniform resource identifier (“URI”) scheme that provides information about a user's interaction with a client device, such as information about what applications a particular user has installed on their client device.

Information about a user's interaction with a client device may include information about application installs and uninstalls, application usage, purchasing history, or any other suitable information. In particular embodiments, information about a user's interaction with a client device may be stored on the client device. In particular embodiments, information about a user's interaction with the client device may be sent to a server operated by a platform operator, and this information may be stored on the server or any other suitable storage media associated with the network operator. In particular embodiments, information about a user's interaction with the client device may be stored locally on the client device and periodically sent to a server, or may be sent to a server immediately after the interaction occurs. Any suitable method for ensuring secure transmission of electronic information may be used, such as encryption, passwords, “handshake” methods, etc. In particular embodiments, a user of the client device may select one or more privacy options disabling, enabling, or controlling the distribution and storage of information related to the user's interaction with the client device.

In particular embodiments information about a user's interaction with the client device may be used to enhance the user's experience with the client device or particular applications on or accessible by the client device. As an example, the user's experience may be enhanced when advertisements or the products the advertisements represent are more valuable to the user, for example be being more interesting, relevant, attractive, or meaningful to the user.

In particular embodiments, an advertisement may be text (which may be HTML-linked), one or more images (which may be HTML-linked), one or more videos, audio, one or more ADOBE FLASH files, a suitable combination of these, or any other suitable advertisement in any suitable digital format presented on one or more web pages, in one or more e-mails, in one or more applications, or in connection with search results requested by a user. In addition or as an alternative, an advertisement may be one or more sponsored stories (e.g. a news-feed or ticker item on social-networking system 160). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes by, for example, having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. The social action may be promoted within or on social-networking system 160. In addition or as an alternative, the social action may be promoted outside or off of social-networking system 160, where appropriate. In particular embodiments, a page may be an on-line presence (such as a webpage or website within or outside of social-networking system 160) of a business, organization, or brand facilitating its sharing of stories and connecting with people. A page may be customized, for example, by adding applications, posting stories, or hosting events.

A sponsored story may be generated from stories in users' news feeds and promoted to specific areas within displays of users' web browsers when viewing a web page associated with social-networking system 160. Sponsored stories are more likely to be viewed by users, at least in part because sponsored stories may involve interactions or suggestions by the users' friends, fan pages, or other connections. In connection with sponsored stories, particular embodiments may utilize one or more systems, components, elements, functions, methods, operations, or steps disclosed in U.S. patent application Ser. No. 13/327,557, entitled “Sponsored Stories Unit Creation from Organic Activity Stream” and filed 15 Dec. 2011, U.S. Patent Application Publication No. us 2012/0203831, entitled “Sponsored Stories Unit Creation from Organic Activity Stream” and filed 3 Feb. 2012 as U.S. patent application Ser. No. 13/020,745, or U.S. Patent Application Publication No. us 2012/0233009, entitled “Endorsement Subscriptions for Sponsored Stories” and filed 9 Mar. 2011 as U.S. patent application Ser. No. 13/044,506, which are all incorporated herein by reference as an example and not by way of limitation. In particular embodiments, sponsored stories may utilize computer-vision algorithms to detect products in uploaded images or photos lacking an explicit connection to an advertiser as disclosed in U.S. patent application Ser. No. 13/212,356, entitled “Computer-Vision Content Detection for Sponsored Stories” and filed 18 Aug. 2011, which is incorporated herein by reference as an example and not by way of limitation. In contrast to a sponsored story, an organic story may include the same information as a sponsored story (such as e.g. a social interaction and a link to a webpage or product), may be targeted in the same way as a sponsored story, and may appear in the same areas as a sponsored story, but the organic story is not promoted by an advertiser. Both organic stories and sponsored stories may be ranked by relevance to the user viewing the advertisement, and the organic and/or sponsored stories may be selected for display to a user based on this rank.

As described above, an advertisement may be text (which may be HTML-linked), one or more images (which may be HTML-linked), one or more videos, audio, one or more ADOBE FLASH files, a suitable combination of these, or any other suitable advertisement in any suitable digital format. In particular embodiments, an advertisement may be requested for display within third-party webpages, social-networking-system webpages, or other pages. An advertisement may be displayed in a dedicated portion of a page, such as in a banner area at the top of the page, in a column at the side of the page, in a GUI of the page, in a pop-up window, over the top of content of the page, or elsewhere with respect to the page. In addition or as an alternative, an advertisement may be displayed within an application or within a game. An advertisement may be displayed within dedicated pages, requiring the user to interact with or watch the advertisement before the user may access a page, utilize an application, or play a game. The user may, for example, view the advertisement through a web browser.

An advertisement may include social-networking-system functionality that a user may interact with. For example, an advertisement may enable a user to “like” or otherwise endorse the advertisement by selecting an icon or link associated with endorsement. Similarly, a user may share the advertisement with another user (e.g. through social-networking system 160) or RSVP (e.g. through social-networking system 160) to an event associated with the advertisement. In addition or as an alternative, an advertisement may include social-networking-system context directed to the user. For example, an advertisement may display information about a friend of the user within social-networking system 160 who has taken an action associated with the subject matter of the advertisement.

Social-networking-system functionality or context may be associated with an advertisement in any suitable manner. For example, an advertising system (which may include hardware, software, or both for receiving bids for advertisements and selecting advertisements in response) may retrieve social-networking functionality or context from social-networking system 160 and incorporate the retrieved social-networking functionality or context into the advertisement before serving the advertisement to a user. Examples of selecting and providing social-networking-system functionality or context with an advertisement are disclosed in U.S. Patent Application Publication No. US 2012/0084160, entitled “Providing Social Endorsements with Online Advertising” and filed 5 Oct. 2010 as U.S. patent application Ser. No. 12/898,662, and in U.S. Patent Application Publication No. US 2012/0232998, entitled “Selecting Social Endorsement Information for an Advertisement for Display to a Viewing User” and filed 8 Mar. 2011 as U.S. patent application Ser. No. 13/043,424, which are both incorporated herein by reference as examples only and not by way of limitation. Interacting with an advertisement that is associated with social-networking-system functionality or context may cause information about the interaction to be displayed in a profile page of the user in social-networking-system 160.

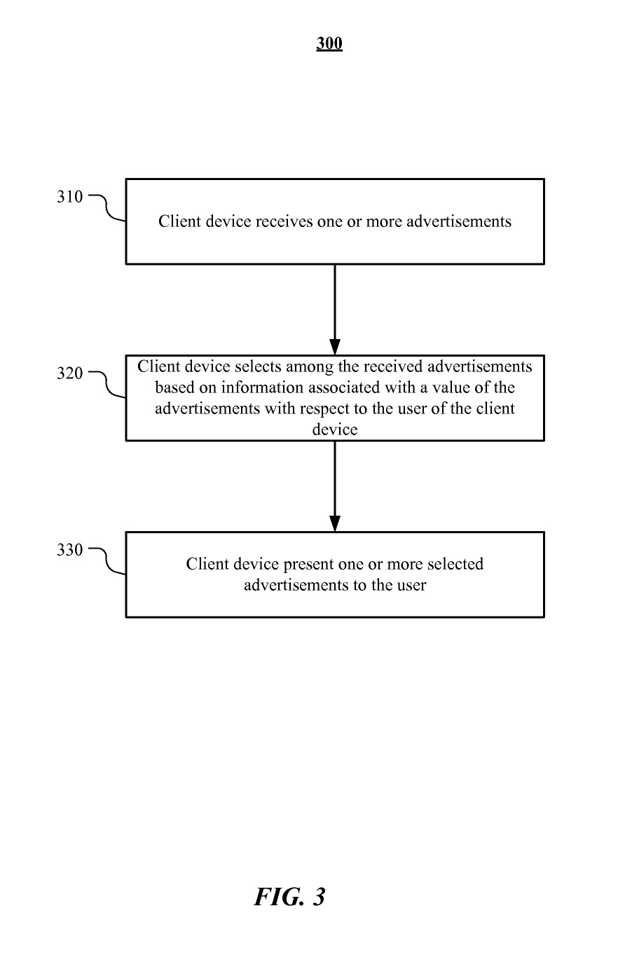

FIG. 3 illustrates an example method 300 for filtering and selecting advertisements to display to a user of a client device. The method may begin at step 310, where the client device receives one or more advertisements for presentation to the user. The client device may receive advertisements directly from one or more advertisers, from an operator of an advertising clearinghouse such as an advertising bidding system, from a social-networking system, from a particular application or program associated with client device, or any suitable combination thereof. In particular embodiments, receiving an advertisement involves receiving components of one or more advertisements, such as text, links, graphics, formatting requirements, etc. This disclosure contemplates that, where appropriate, receiving advertisement includes receiving components of advertisements. In particular embodiments, the advertisements or advertisement components received by the client device may be pre-screened or pre-filtered, such as by selecting advertisements most relevant to a particular advertising space or targeting advertisements to the user that are most relevant to the user or likely to engage the user's interest. For example, an advertiser may realize higher conversion rates (and therefore higher return on investment (ROI) from advertising) by identifying and targeting users that are more likely to find its advertisements more relevant or useful. Information about the user's past behavior or about the past behavior of individuals or groups having similar relevant characteristics as the user may be used to target advertisements to the user. For example, such information may be user-profile information in social-networking system 160 that identifies or is related to a user of the social-networking system. In particular embodiments, in a social-networking system, one or more of the advertisements may be attached to or otherwise accompany a particular story (whether sponsored or unsponsored). For example, a social networking system may send a story to a client device, and include as attachments advertisements that may potentially be displayed in association with the story.

As examples and not by way of limitation, particular embodiments may target users with the following: invitations to or notice about events; information about coupons, deals, or wish-list items; information about friends' life events; information regarding groups; advertisements; or social advertisements. Such targeting may occur, where appropriate, on or within social-networking system 160, off or outside of social-networking system 160, or on mobile computing devices of users. When on or within social-networking system 160, such targeting may be directed to users' news feeds, search results, e-mail or other in-boxes, or notifications channels or may appear in particular area of web pages of social-networking system 160, such as a right-hand side of a web page in a concierge or grouper area (which may group along a right-hand rail advertisements associated with the same concept, node, or object) or a network-ego area (which may be based on what a user is viewing on the web page and a current news feed of the user). When off or outside of social-networking system 160, such targeting may be provided through a third-party website, e.g., involving an ad exchange or a social plug-in. When on a mobile computing device of a user, such targeting may be provided through push notifications to the mobile computing device.

Targeting criteria used to identify and target users may include explicit, stated user interests on social-networking system 160 or explicit connections of a user to a node, object, entity, brand, or page on social-networking system 160. In addition or as an alternative, such targeting criteria may include implicit or inferred user interests or connections (which may include analyzing a user's history, demographic, social or other activities, friends' social or other activities, subscriptions, or any of the preceding of other users similar to the user (based, e.g., on shared interests, connections, or events)). Particular embodiments may utilize platform targeting, which may involve platform and “like” impression data; contextual signals (e.g. “Who is viewing now or has viewed recently the page for COCA-COLA?”); light-weight connections (e.g. “check-ins”); connection lookalikes; fans; extracted keywords; EMU advertising; inferential advertising; coefficients, affinities, or other social-graph information; friends-of-friends connections; pinning or boosting; deals; polls; household income, social clusters or groups; products detected in images or other media; social- or open-graph edge types; geo-prediction; views of profile or pages; status updates or other user posts (analysis of which may involve natural-language processing or keyword extraction); events information; or collaborative filtering. Identifying and targeting users may also include privacy settings (such as user opt-outs), data hashing, or data anonymization, as appropriate.

To target users with advertisements, particular embodiments may utilize one or more systems, components, elements, functions, methods, operations, or steps disclosed in the following, which are all incorporated herein by reference as examples and not by way of limitation: U.S. Patent Application Publication No. US 2009/0119167, entitled “Social Advertisements and Other Informational Messages on a Social Networking Website and Advertising Model for Same” and filed 18 Aug. 2008 as U.S. patent application Ser. No. 12/193,702; U.S. Patent Application Publication No. US 2009/0070219, entitled “Targeting Advertisements in a Social Network” and filed 20 Aug. 2008 as U.S. patent application Ser. No. 12/195,321; U.S. Patent Application Publication No. US 2012/0158501, entitled “Targeting Social Advertising to Friends of Users Who Have Interacted With an Object Associated with the Advertising” and filed 15 Dec. 2010 as U.S. patent application Ser. No. 12/968,786; or U.S. Patent Application Publication No. US 2012/0166532, entitled “Contextually Relevant Affinity Prediction in a Social-Networking System” and filed 23 Dec. 2010 as U.S. patent application Ser. No. 12/978,265. While the above discussion refers to targeting advertisements to a user by using information related to a social networking system, this disclosure contemplates using any suitable information gathered from any suitable source to target an advertisement to a user.

After (possibly pre-targeted or pre-selected) advertisements are received by the client device in step 310, the client device in step 320 selects from among the received advertisements which advertisements, if any, to present to the user of the client device. In particular embodiments, selecting one or more advertisement involves building or constructing the advertisement out of advertising components received in step 310. In particular embodiments, selecting one or more advertisements include selecting an order for the advertisements. In particular embodiments, the selection may be based on information stored locally on the client device, which may enhance user privacy by, for example, reducing the amount of information shared with another entity or device. For example, a client device may be able to determine what applications a user has installed (for example, through a URI scheme) or what interactions a user has with a client device or applications on the client device. In particular embodiments, such interactions may include usage information, purchasing information, information relating to progress in an application (such as in games), or another other suitable information. In particular embodiments, the client device may access information stored on another device or remote server to aid in the selection process performed by the client device. In particular embodiments, selection of advertisements by the client device may be based at least in part on information associated with a value of the advertisements with respect to the user, such as information relating to the user's preferences, likes, activities, associates, or any other suitable information. For example, if a user has a specific application installed, an advertisement promoting installation of that application may have a low value for the user. As another example, a user may value advertisements for applications that the user interacts regularly with or has purchased upgrades for. As another example, a user may value advertisements for applications or products similar to an application or product that a user has frequently interacted with or otherwise indicated that the user likes. As another example, a user's advertising preferences, whether explicitly stated or determined from a user's interactions with previous advertisements, may indicate how the user values the ad. Examples of a user's previous interaction with advertisements that a client device could use to select advertisements include the number of times a user has previously been exposed to a similar advertisement. A user may place less value on advertisements or advertising campaigns that a user has been exposed to many times. In particular embodiments, information associated with a value of an advertisement with respect to a user may be determined from a social graph, such as from information associated with nodes or edges that are relevant or relate to the user. In particular embodiments, information associated with a value of the advertisements with respect to the user may include estimates of what the user may value based on information of what other individuals with one or more similar, relevant characteristics may value. In particular embodiments, information associated with a value of the advertisements with respect to the user may include the popularity of an advertisement or a product association with the advertisement. For example, an advertisement that is very popular may be more valued by the user. In particular embodiments, information associated with a value of an advertisement with respect to the user includes information about an advertiser of received advertisements, such as whether an advertiser is promoting one or more of the advertisements or targeting specific users or groups of users. For example, in the context of a social network, advertisements that are sponsored attachments to a story may be preferred over advertisements that are non-sponsered attachments. In addition or the alternative, any of the information or methods discussed above in connection with targeting an advertisement to a user may also be used by a client device to select one or more advertisements. Moreover, while this disclosure describes particular examples of the types of information used by a client device to select among received advertisements, this disclosure contemplates a client device selecting among received advertisements based on any suitable information associated with a value of the advertisements with respect to the user.

Once the client device has selected among the received advertisements, in step 330 the client devices presents one or more of the selected advertisements to the user. An advertisement may be presented or otherwise delivered using plug-ins for web browsers or other applications, iframe elements, news feeds, tickers, notifications (which may include, for example, e-mail, Short Message Service (SMS) messages, or notifications), or other means. An advertisement may be presented or otherwise delivered to a user on a mobile or other computing device of the user. In connection with delivering advertisements, particular embodiments may utilize one or more systems, components, elements, functions, methods, operations, or steps disclosed in the following, which are all incorporated herein by reference as examples and not by way of limitation: U.S. Patent Application Publication No. US 2012/0159635, entitled “Comment Plug-In for Third-Party System” and filed 15 Dec. 2010 as U.S. patent application Ser. No. 12/969,368; U.S. Patent Application Publication No. US 2012/0158753, entitled “Comment Ordering System” and filed 15 Dec. 2010 as U.S. patent application Ser. No. 12/969,408; U.S. Pat. No. 7,669,123, entitled “Dynamically Providing a News Feed About a User of a Social Network” and filed 11 Aug. 2006 as U.S. patent application Ser. No. 11/503,242; U.S. Patent Application Publication No. US 2008/0040475, entitled “Providing a News Feed Based on User Affinity in a Social Network Environment” and filed 11 Aug. 2006 as U.S. patent application Ser. No. 11/503,093; U.S. Patent Application Publication No. US 2012/0072428, entitled “Action Clustering for News Feeds” and filed 16 Sep. 2010 as U.S. patent application Ser. No. 12/884,010; U.S. Patent Application Publication No. US 2001/0004692. In particular embodiments, advertisements may be presented to a user a user in pre-determined groups or number. As an example, a newsfeed of a social networking website may have a predetermined number of spots, such as three, for advertisements accompanying a story in the newsfeed. In such instances the client device will only display the appropriate number of ads. Space limitations may also be taken into account during the selection process of step 320. In particular embodiments, advertisements may be displayed to a user in one or more locations that the user is likely to click on or otherwise interact with the advertisement. Such information may be determined based on a user's explicit preferences, a user's past behavior, the past behavior of other individuals with similar relevant characteristics, or one or more characteristics of a client device, such as the device's form factor, screen size, orientation, or any or other suitable characteristic. While this disclosure describes or illustrates particular advertisements being delivered in particular ways and in connection with particular content, this disclosure contemplates any suitable advertisements delivered in any suitable ways and in connection with any suitable content.

Particular embodiments may repeat one or more steps of the method of FIG. 3, where appropriate. Although this disclosure describes and illustrates particular steps of the method of FIG. 3 as occurring in a particular order, this disclosure contemplates any suitable steps of the method of FIG. 3 occurring in any suitable order. Moreover, although this disclosure describes and illustrates particular components, devices, or systems carrying out particular steps of the method of FIG. 3, this disclosure contemplates any suitable combination of any suitable components, devices, or systems carrying out any suitable steps of the method of FIG. 3.

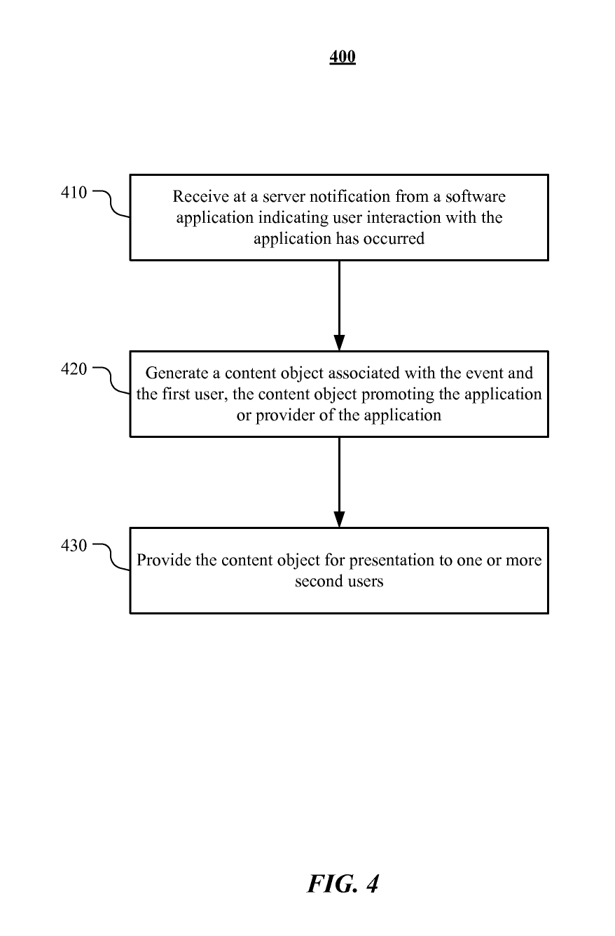

FIG. 4 illustrates an example method 400 for displaying a promoted content object to a user of a client device. The method may begin at step 410, where a server computing system receives a notification from an application on a client device relating to one or more interactions between the user of the device (the first user) and the application. Information about a user's interaction with an application may include information about application installs and uninstalls, application usage (such as time spent using the application, specific actions taken within the application, etc), purchasing history related to the application or use of the application, or any other suitable information. In particular embodiments, the notifications received by the server comply with specifications set forth in a software development kit. For example, the notifications may include specific information identifying the application or the user of the application, encrypt or encode information in the notification in a specific way, or comply with specific functionality, such as a single-sign on feature.

At step 420, the server generates a content object to present to a second user, where the content object is associated with the first user's interaction with the application. The content object is suitable for display on a client device and may include text, graphics, pictures, specific formatting, any other suitable content, or any suitable combination thereof. Examples of content objects include emails, posts, an item in a feed (such as a newsfeed), an item in a ticker, a pop-up, or any other suitable content object. In particular embodiments, the first user and the second user may be users of a social-networking system, in which each user has a node and the first and second user's nodes are connected by one or more edges. In particular embodiments, a content object promotes the application or the provider of the application that the first user interacted with. As an example, promoting an application or the provider of the application may include descriptions of or relating to the first user's interaction, a summary of the first user's interaction, a general notice that the first user is interacting with the application, information aggregating the first user's current and past interactions (for example, the total progress of the first user in an game, or the total progress in a given time period), the first user's preferences regarding the application, the first user's ranking or feedback of the application (for example, that the first user “likes” the application), a notice that the first user interacted with one of the application provider's products, a notice regarding the first user's preferences or feedback of the application provider, or any suitable combination thereof. While this disclosure describes specific examples of a content object promoting an application or provider of the application, this disclosure contemplates any suitable content object promoting the application or provider of the application.

At step 430, the content object generated in step 420 is provided for presentation to the second user on the display of the second user's client device. The presented content object may take any suitable form, as described above. For example, where the second user is a user of a social-networking system the content object may include a news feed item, a ticker item, a post, a status update, a story, a pop-up notification, a notification within the social network or within an application capable of communicating with the social network, or any other suitable content object. In particular embodiments, the content object may be targeted towards the second user, for example by determining that the content object is relevant to the user based on the user's interests, connections, activity, or any other suitable information. In particular embodiments, any suitable determinations described above for determining whether to target an advertisement to a user may also be used to determine whether to target a content object to a user. In particular embodiments, the second user may interact with the content object, for example by clicking on the content object or hovering over the content object, to trigger any suitable functionality, such as directing the user to a webpage or application store item associated with the application or provider of the application. In particular embodiments, this interaction may itself be presented to one or more third users. Particular embodiments may repeat one or more steps of the method of FIG. 4, where appropriate. Although this disclosure describes and illustrates particular steps of the method of FIG. 4 as occurring in a particular order, this disclosure contemplates any suitable steps of the method of FIG. 4 occurring in any suitable order. Moreover, although this disclosure describes and illustrates particular components, devices, or systems carrying out particular steps of the method of FIG. 4, this disclosure contemplates any suitable combination of any suitable components, devices, or systems carrying out any suitable steps of the method of FIG. 4.

In particular embodiments, the provider an application receives advertising benefits for complying with one or more specifications of the software development kit discussed in step 410. As used herein, a provider of the software application may be the creator or developer of the software application, the entity distributing or selling the application, the entity advertising the application, or any suitable combination thereof. As an example, the provider of the application receives advertising benefits simply because content objects are being generated promoting themselves or their applications. As another example, the provider may be offered the ability to advertise at a lower rate or in larger quantities than they otherwise would have. As another example, the provider may be offered the ability to bid or pay for advertisements on a specific basis, such as cost per click or cost per install, or receive special bidding or payment preferences for one or more bidding/payment bases. As another example, a provider may be offered the ability to promote the advertised product in specific ways. For example, in the context of a social network, the provider may be offered the ability to further promote the content object, for example by displaying the content object to additional users, presenting the content object for a longer period of time to the second user, presenting the content object in a more conspicuous way or location to the second user, presenting the content object in a related application, presenting the content object at a time where the second user is more likely to interact with the content object (such as when the second user has just searched for the application or a related application), presenting the content object with one or more links or other interactive elements, increase the likelihood that the content object will be targeted to a user, or any suitable combination thereof. Moreover, while this disclosure describes specific advertising benefits that may be provided to a provider of an application associated with the content object, this disclosure contemplates any suitable advertising benefits provided to the provider.

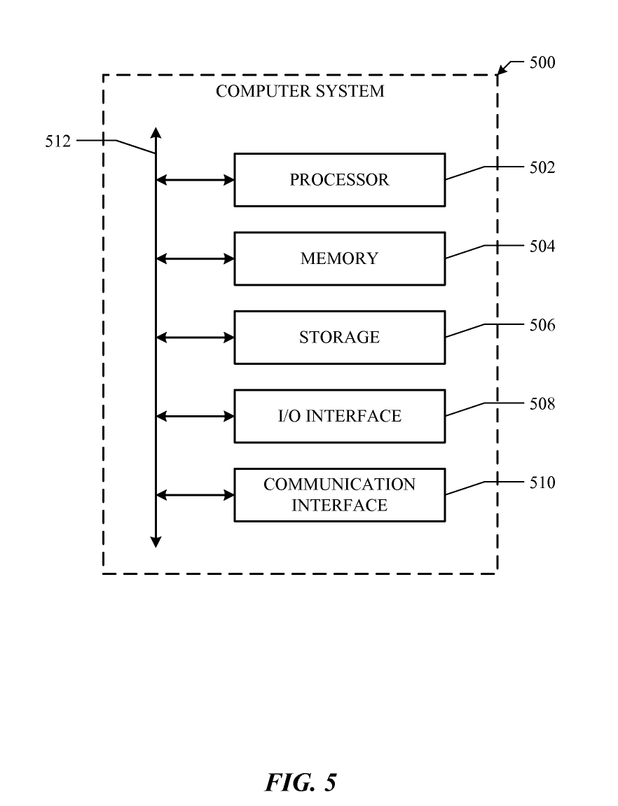

FIG. 5 illustrates an example computer system 500. In particular embodiments, one or more computer systems 500 perform one or more steps of one or more methods described or illustrated herein. In particular embodiments, one or more computer systems 500 provide functionality described or illustrated herein. In particular embodiments, software running on one or more computer systems 500 performs one or more steps of one or more methods described or illustrated herein or provides functionality described or illustrated herein. Particular embodiments include one or more portions of one or more computer systems 500. Herein, reference to a computer system may encompass a computing device, and vice versa, where appropriate. Moreover, reference to a computer system may encompass one or more computer systems, where appropriate.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In particular embodiments, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 502 includes hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. This disclosure contemplates processor 502 including any suitable number of any suitable internal caches, where appropriate. As an example and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translation for processor 502. In particular embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In particular embodiments, memory 504 includes main memory for storing instructions for processor 502 to execute or data for processor 502 to operate on. As an example and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In particular embodiments, one or more memory management units (MMUs) reside between processor 502 and memory 504 and facilitate accesses to memory 504 requested by processor 502. In particular embodiments, memory 504 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memories 504, where appropriate. Although this disclosure describes and illustrates particular memory, this disclosure contemplates any suitable memory.

In particular embodiments, storage 506 includes mass storage for data or instructions. As an example and not by way of limitation, storage 506 may include a hard disk drive (HDD), a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In particular embodiments, storage 506 is non-volatile, solid-state memory. In particular embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In particular embodiments, I/O interface 508 includes hardware, software, or both, providing one or more interfaces for communication between computer system 500 and one or more I/O devices. Computer system 500 may include one or more of these I/O devices, where appropriate. One or more of these I/O devices may enable communication between a person and computer system 500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In particular embodiments, communication interface 510 includes hardware, software, or both providing one or more interfaces for communication (such as, for example, packet-based communication) between computer system 500 and one or more other computer systems 500 or one or more networks. As an example and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising:
by a client computing device, receiving a plurality of advertisements for presentation to a user associated with the client computing device;
by the client computing device, selecting from among the advertisements for presentation to the user based on information stored locally on the client computing device associated with a value of the advertisements with respect to the user;
by the client computing device, presenting to the user one or more of the advertisements as selected by the client computing device.

2. The method of claim 1, wherein the client computing device comprises a mobile computing device.

3. The method of claim 1, wherein receiving a plurality of advertisements comprises receiving at least one advertisement that is targeted to the user of the client computing device.

4. The method of claim 1, wherein:
receiving a plurality of advertisements comprises receiving one or more advertisement components; and
selecting from among the advertisements comprises selecting one or more advertisements to construct from the received advertising components.

5. The method of claim 1, wherein presenting to the user one or more of the advertisements as selected by the client computing device comprises:
determining one or more advertising locations on the device where the user is likely view or interact with the advertisement; and
presenting to the user one or more of the advertisements as selected in at least one of the determined advertising locations.

6. The method of claim 1, wherein the information stored locally on the client computing device comprises information relating to the installation status of one or more applications on a computing device.

7. The method of claim 1, wherein the information stored locally on the client computing device comprises information relating to the user's usage of one or more applications on a computing device.

8. The method of claim 1, wherein the user is a user of a social-networking system, the social-networking system comprising a graph that comprises a plurality of nodes and edges connecting the nodes, at least one node in the graph corresponding to the first user.

9. The method of claim 8, wherein at least one of the advertisements is presented to the user in a newsfeed associated with the user.

10. The method of claim 8, wherein the information stored locally on the client computing device associated with a value of the advertisements with respect to the user comprises information expressly or implicitly determined from information associated with at least one edge or node in the social-networking system, the at least one edge or node associated with the user.

11. The method of claim 8, wherein receiving a plurality of advertisements for presentation to a user associated with the client computing device further comprises receiving one or more stories, each story associated with a plurality of the plurality of advertisements.

12. One or more computer-readable non-transitory storage media embodying software that is operable when executed to:
receive a plurality of advertisements for presentation to a user associated with the client computing device;
select from among the advertisements for presentation to the user based on information stored locally on the client computing device associated with a value of the advertisements with respect to the user;
present to the user one or more of the advertisements as selected by the client computing device.

13. The media of claim 12, wherein the client computing device comprises a mobile computing device.

14. The media of claim 12, wherein at least one of the plurality of advertisements is targeted to the user of the client computing device.

15. The media of claim 12, wherein:
the software that is operable when executed to receive a plurality of advertisements for presentation to a user associated with the client computing device comprises software that is operable when executed to receive a plurality of advertising components; and
the software that is operable when executed to select from among the advertisements for presentation to the user comprises software that is operable when executed to select from among the advertising components to construct one or more advertisements for presentation to the user.

16. The media of claim 12, wherein the software that is operable when executed to present to the user one or more of the advertisements as selected by the client computing device comprises software that is operable when executed to:
determine one or more advertising locations on the device where the user is likely view or interact with the advertisement; and
present to the user one or more of the advertisements as selected in at least one of the determined advertising locations.

17. The media of claim 12, wherein the information stored locally on the client computing device comprises information relating to the installation status of one or more applications on a computing device.

18. The media of claim 12, wherein the information stored locally on the client computing device comprises information relating to the user's usage of one or more applications on a computing device.

19. The media of claim 12, wherein the user is a user of a social-networking system, the social-networking system comprising a graph that comprises a plurality of nodes and edges connecting the nodes, at least one node in the graph corresponding to the first user.

20. A system comprising:
one or more processors; and
a memory coupled to the processors comprising instructions executable by the processors, the processors being operable when executing the instructions to:
receive a plurality of advertisements for presentation to a user associated with the client computing device;
select from among the advertisements for presentation to the user based on information stored locally on the client computing device associated with a value of the advertisements with respect to the user;
present to the user one or more of the advertisements as selected by the client computing device.
